(19) United States
(12) Patent Application Publication
(10) Pub. No.: US 2012/0139274 A1
(43) Pub. Date: Jun. 7, 2012

(54) CONTAINER HANDLING ARRANGEMENT

(75) Inventor: Tim Fleischer, Port Elizabeth (ZA)

(73) Assignee: Versa-tainer (Pty) Ltd., Port Elizabeth (ZA)

(21) Appl. No.: 13/378,785

(22) PCT Filed: Jun. 18, 2010
(86) PCT No.: PCT/IB2010/052755

§ 371 Date: Feb. 24, 2012

(30) Foreign Application Priority Data
Jun. 18, 2009 (ZA) 2009/04276

(51) Int. Cl. B66C 1/16

(52) U.S. Cl. 294/67.3

(57) ABSTRACT

THIS invention relates to a container handling arrangement and more particularly, but not exclusively, to a container handling arrangement for use in handling a bottom discharge container. The container handling arrangement, suitable for handling a bottom discharge container having a floor, at least a portion of which is displaceable between a closed position and an open position, includes a frame structure adapted releasably to engage the container, and an actuating mechanism provided on the frame structure. The actuating mechanism is displaceable between a secure position in which it retains the floor of the container in a closed position, and a release position, in which it allows the floor of the container to be displaced to the open position.

### BACKGROUND OF THE INVENTION

THIS invention relates to a container handling arrangement and more particularly, but not exclusively, to a container handling arrangement for use in handling a bottom discharge container.

It should be appreciated that the term “Container handling arrangement” as used in this specification relates to an apparatus suitable for use in handling various containers of a bottom discharge configuration, and the term “handling” specifically incorporates the actions of opening and closing the displaceable floor or door of the container.

Various different containers for transporting bulk material by road exist. Generally, these containers are designed to receive bulk material through an upper opening during loading, and to discharge the material through the upper opening, or through a discharge hatch in a front or rear wall of the container during unloading.

One alternative container arrangement has been disclosed in the applicant's prior South African patent ZA2001/8903 entitled “Container for transporting bulk material”. The particular container includes a displaceable floor comprising one or more movable sections being pivotable between a raised, closed position in which it extends across the bottom of the container to form a base of the container, and a lowered, open position in which the floor is pivoted away from the bottom of the container for discharging bulk material from the container. The above container (hereinafter referred to as a “bottom discharge container”) has proven useful in trade and industry, but the offloading and actuation of the pivotable floor has in the past proven to be a cumbersome exercise, as existing container handling devices were not designed with the handling and discharging of this kind of container in mind. It should be noted that variations of this container may also be used, for example in which the container has an internal cable arrangement adapted to open and close the door or doors, or alternatively where the doors include receiving formations extending from edges thereof, and which can be displaced in order to open and close the doors.

It is accordingly an object of the invention to provide a container handling arrangement that will, at least partially, address the above shortcoming.

It is also an object of the invention to provide a container handling arrangement that will be a useful alternative to existing container handling arrangements known in the art.

### SUMMARY OF THE INVENTION

According to the invention there is provided a container handling arrangement, suitable for handling a bottom discharge container having a floor, at least a portion of which is displaceable between a closed position and an open position, the handling arrangement including:

a frame structure adapted releasably to engage the container; and

an actuating mechanism provided on the frame structure, the actuating mechanism being displaceable between a secure position in which it retains the floor of the container in a closed position, and

a release position, in which it allows the floor of the container to be displaced to the open position.

At least one actuating mechanism may be provided at each end of the frame structure in order to engage the displaceable floor on opposite ends thereof.

There is also provided for two actuating mechanisms to be provided on each end of the frame structure, in order to engage the displaceable floor in an embodiment where the displaceable floor comprises two opposing hinged door sections.

There is provided for each actuating mechanism to be in the form of a piston and cylinder assembly that extends from the frame structure, with a free end of the piston and cylinder assembly being adapted to engage the displaceable floor of the container.

The free end may terminate in a disc configured and dimensioned to engage a complementary guide channel extending from the displaceable floor of the container.

There is also provided for each actuating mechanism to be in the form of a slideable pin that depends from the frame structure and which is slideable relative to the frame structure, and with an end of the slideable pin being adapted to engage a door release mechanism forming part of the container.

The slideable pin may be displaceable between an open and a closed position by way of a piston and cylinder arrangement.

There still further provided for each actuating mechanism to be in the form of a displaceable chain or cable extending from the frame structure, with a free end of the displaceable chain or cable being securable to the floor of the container.

The free ends of the chains can be retracted at least partially into the frame structure towards a secure position in which it retains the floor of the container in a closed position, and can be at least partially displaced from the frame structure so as to allow the floor of the container to be displaceable under gravity to the open position.

The frame structure may include corner engagement arrangements adapted releasably to engage upper corners of the container.

Preferably, the corner engaging arrangements include twist lock assemblies suitable for engaging complementary apertures provided in the corner sections of the container.

Lifting lugs may be provided on the frame structure, which may in use be secured to a hoisting mechanism.

In an alternative embodiment, the frame structure may be releasably securable to a container spreader assembly, as is known in the art, by way of locking pin arrangements. The locking pin arrangements may be in the form of twist lock arrangements.

In this embodiment, the frame structure may include auxiliary safety pins that are adapted to secure the locking pin arrangements in a locked position.

Preferably, each safety pin is in the form of a retractable pin that can be displaced between an unlocked position, in which the pin is retracted into the frame, and a locked position in which the pin protrudes from the frame in order to engage the locking pin assemblies of the spreader.

### BRIEF DESCRIPTION OF THE DRAWINGS

Embodiments of the invention are described by way of non-limiting examples, and with reference to the accompanying drawings in which:

FIG. 1 is a perspective view of a container handling arrangement in accordance with a first embodiment of the invention;

FIG. 2 is a perspective view of the container handling arrangement of FIG. 1 having engaged a bottom discharge container, the floor of the bottom discharge container being in a closed position;

FIG. 3 shows the handling arrangement of FIG. 2 with the floor of the container having been displaced to the open position;

FIG. 4 is a bottom perspective view of a container handling arrangement in accordance with a second embodiment of the invention;

FIG. 5 is a top perspective view of the container handling arrangement of FIG. 4;

FIG. 6 is a perspective view of a container handling arrangement in accordance with a third embodiment of the invention, prior to the container handling arrangement having being engaged by an existing spreader assembly which is also shown in the figure;

FIG. 7 shows the container handling arrangement of FIG. 6, wherein the spreader assembly has engaged the container handling arrangement, and in which the container handling arrangement has engaged a container, with the displaceable floor or doors of the container still in a closed position; and

FIG. 8 shows the configuration of FIG. 7, but with the displaceable floor or doors having been displaced to an open position.

### DETAILED DESCRIPTION OF INVENTION

Referring to the drawings, in which like numerals indicate like features, non-limiting examples of container handling arrangements in accordance with the invention is generally indicated by reference numeral 10, 100 and 150.

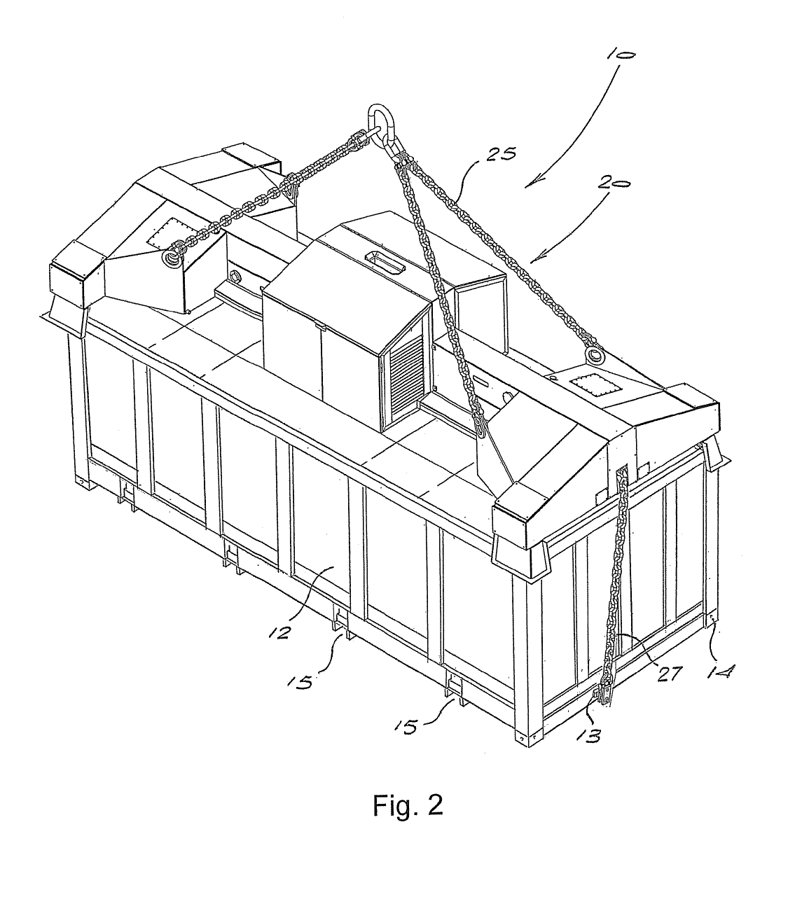

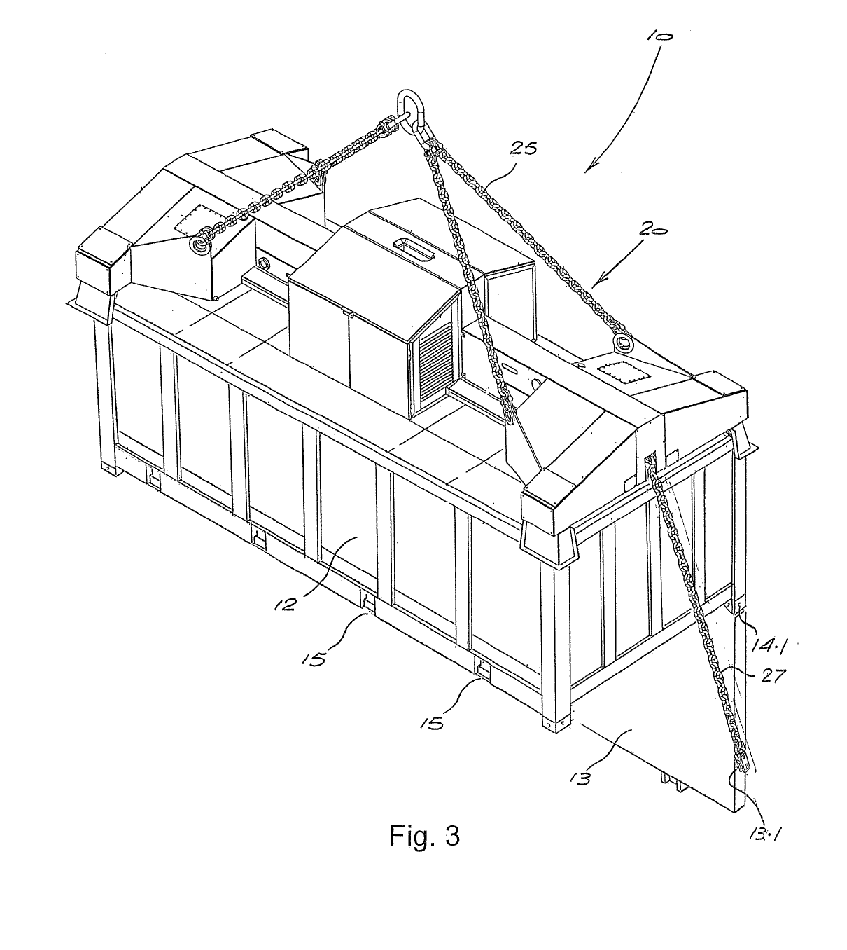

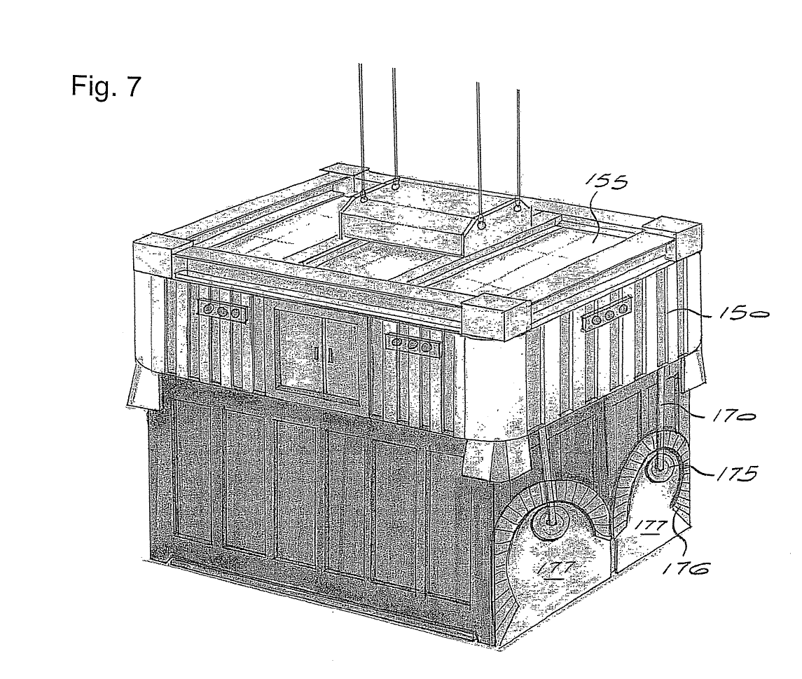

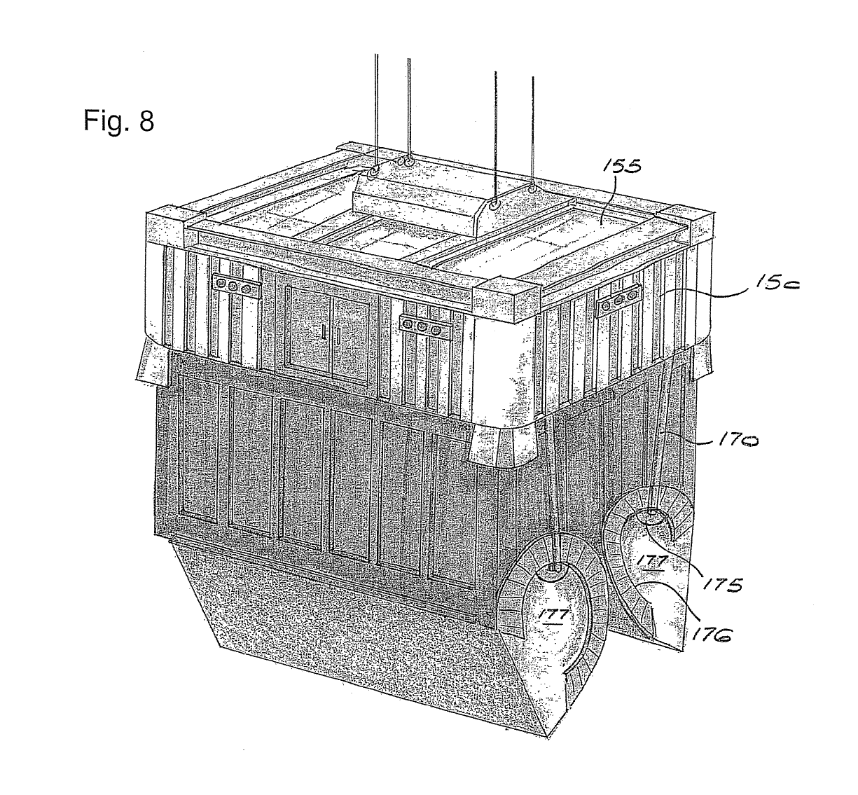

The container handling arrangements 10, 100 and 150 find application in the handling of bottom discharge containers in general, including the container 12 forming the subject matter of the applicant's prior patent ZA2001/8903 entitled “Container for transporting bulk material”, as well as variations thereof. As discussed above, the bottom discharge container disclosed in said patent includes a displaceable floor that is pivotable between a raised, closed position in which it extends across the bottom of the container to form a base of the container, and a lowered, open position in which the floor is pivoted away from the bottom of the container for discharging bulk material from the container. The displaceable floor may be in the form of a single door as shown in FIGS. 2 and 3, but may also comprise two opposing doors as shown in FIGS. 7 and 8. The container handling arrangements 10, 100 and 150 have been designed to facilitate convenient handling of such containers, as well as the discharging of the load of the container.

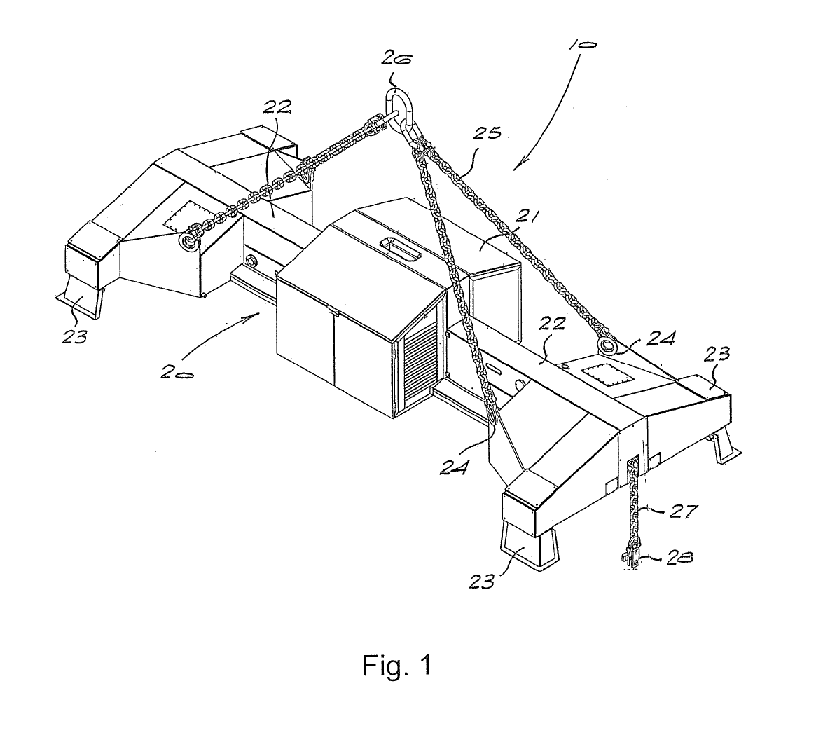

Referring first to FIGS. 1 to 3, the container handling arrangement 10 includes a frame structure 20, which is configured and dimensioned to extend essentially the entire length of the container 12. The frame structure 20 includes a housing section 21 inside which a drive mechanism (which may be in the form of a motor, gearbox and pulley arrangement) is housed. A cross channel 22 extends along the length of the frame structure 20, and houses an actuation chain 27 as is described in more detail below. Lifting lugs 24 are provided on the frame structure 20, and allows the frame structure 20, and thus the container handling arrangement 10, to be lifted and displaced using an external hoisting means (not shown). Lifting chains 25 ending in a crane hook 26 may be used to connect the container handling arrangement 10 to the hoisting means.

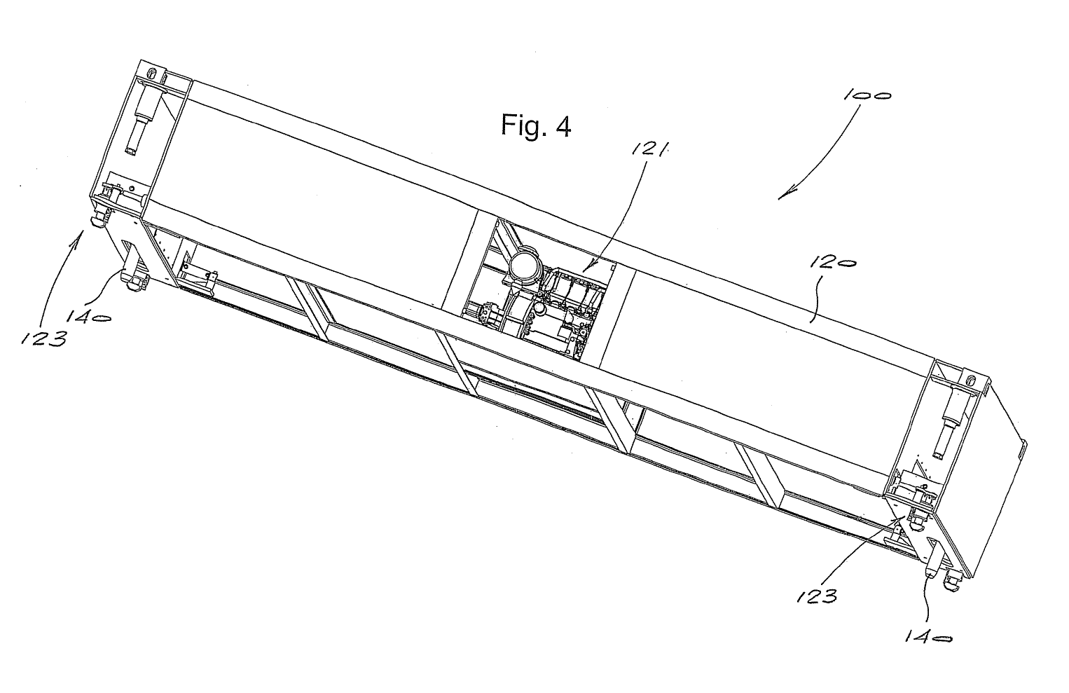

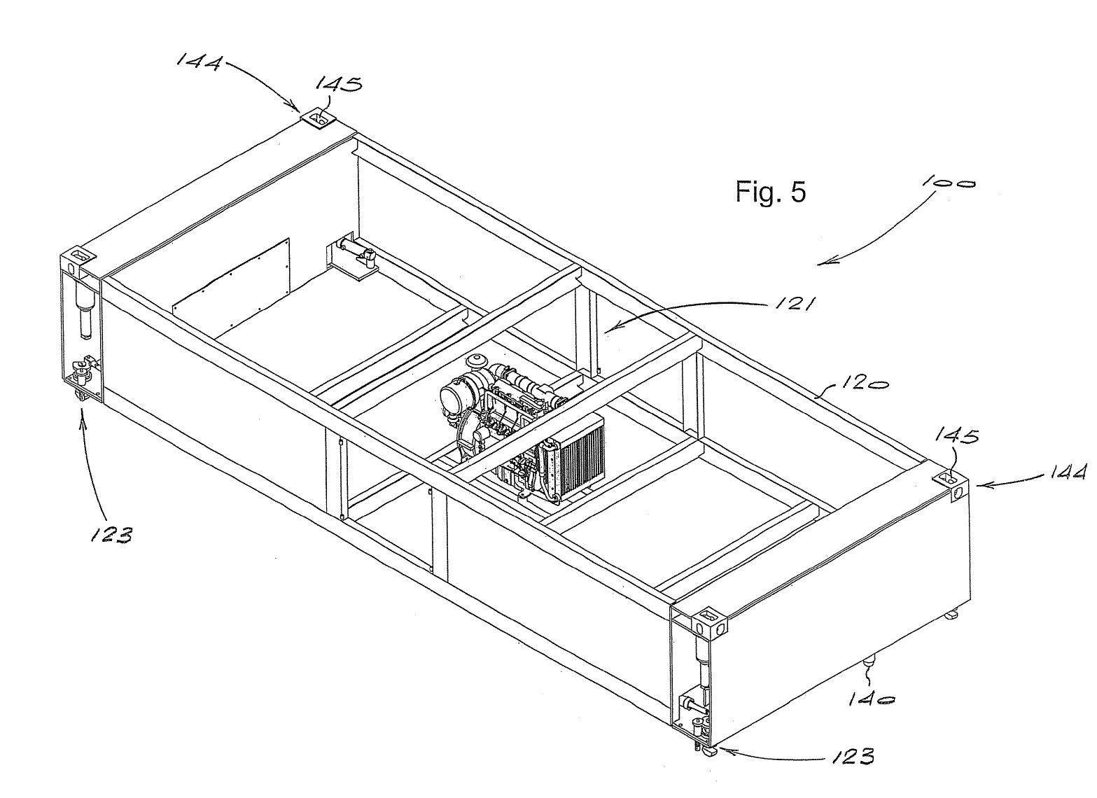

The container handling arrangement 10 also include four corner engagement arrangements 23. These arrangements are specifically designed to fit over upper corner zones of the container, as is shown in FIGS. 2 and 3. Locking pin assemblies in the form of twist locks, which in this example is remotely actuated, are provided on the corner engagement sections 23, and are adapted to engage complementary receiving means, such as suitable apertures (not shown) provided in the corner zones of the container. This allows the frame structure 20, and thus the container handling arrangement, to be secured to the container. It will however be appreciated that there may be many different securing arrangements, and any arrangement which allows the corner engagement sections 23 to be releasably secured to the container 12 will suffice. The detail design of the particular locking pin assemblies used in the embodiment shown in the drawings is therefore not limiting, and as such of lesser importance. There is however provided for the locking pin arrangements to be similar to those described with reference to FIGS. 4 and 5 (i.e. twist locks 123). It is however an important, although not limiting, feature of the invention that the locking arrangement should preferably be automated and remotely actuated.

Importantly, the container handling arrangement 10 includes an actuating arrangement that is adapted to be displaceable between a secured position (FIG. 2) in which the floor 13 of the container 12 is retained in a closed position, and a displaced position (FIG. 3) in which the floor 13 of the container 12 is allowed to be displaced under gravity to the open position. In this example, the actuation arrangement is in the form of an actuation chain 27 that is displaceable relative to the frame structure 20 by way of a motor, gearbox and pulley arrangement. As mentioned above, the drive mechanism is located inside a housing 21 provided on the frame structure 20, and from there the actuation chains 27 extend in opposite directions, via the cross-channels 22, to the ends of the frame structure 20. Ends of the cable extend from the frame structure 20, and terminate in engagement lugs 28 that can releasably engage engagement spigots 13.1 extending from the floor 13 of the container 12.

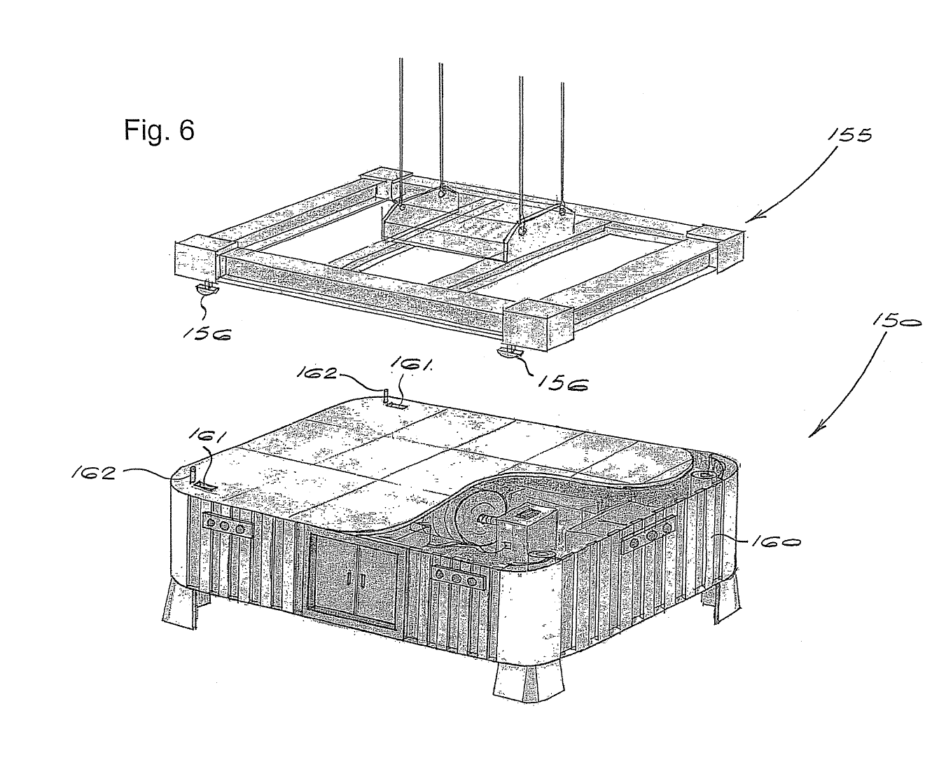

A second embodiment of the container handling arrangement 100 is shown in FIGS. 4 and 5, and also includes a frame structure 120 that houses a drive mechanism 121. The container handling arrangement 100 includes corner engagement arrangements 123 which are similar to the corner engagement arrangements of the first embodiment. In this case the actuating mechanism is however in the form of slideable pins 140 which are adapted to engage a door release mechanism (not shown) forming part of the container. The pins are slideable between a closed position, in which the doors are also retained in a closed position, and an open position, in which the doors are displaceable to the open position. The slideable pins 140 are typically driven by piston and cylinder assemblies. A further difference of this embodiment over the embodiment described in FIGS. 1 to 3 is that the frame structure 120 is adapted to be engageable by a standard container spreader as is known in the art, and which is shown in FIG. 6 in relation to a third embodiment of a container handling arrangement in accordance with the invention. To facilitate this, engagement apertures 145 are provided in the upper corner zones 144 of the frame structure 120, and are configured and dimension for receiving twist lock formations extending from the spreader arrangement. In this way, a spreader arrangement known in the art can be converted to handle bottom discharge containers.

A third embodiment of the container handling arrangement 150 in accordance with the invention is shown in FIGS. 6 to 8. The frame structure 160 of this embodiment is functionally similar to that of the embodiment described above with reference to FIGS. 4 and 5. The frame structure 160 is also adapted to be engaged by a standard spreader 155, and in particular includes receiving apertures 161 for receiving twist lock engagement means 156 extending from the spreader 155. Locking pins 162 extend from the frame structure 160, and are displaceable between a release position, in which the pins are retracted into the frame structure 160, and a locked position (shown in FIG. 6) in which the pins protrudes from the frame structure, and in use forms a mechanical barrier against the rotation of the twist lock engagement means 156 which secure the spreader 155 to the frame structure 160. This prevents the spreader 155 from disengaging the container handling arrangement 150 without a clearance signal from the control system of the container handling arrangement, and therefore constitutes an important safety feature. It will be appreciated that the locking pins 162 can also be used with the container handling arrangement 100 of FIGS. 4 and 5, although not explicitly shown in the drawings.

The major difference between the second 100 and third 150 embodiment of the container handling arrangement resides in the actuating mechanism utilized. The third embodiment of the container handling arrangement 150 includes an actuating mechanism in the form of a plurlality of piston and cylinder assemblies 170 extending therefrom. The piston and cylinder assemblies 170 terminate in disc-like engagement formations 175, which are in turn adapted to engage a complementary opening channel 176 that extend from flanges 177 forming part of the doors of the container. The channels 176 are of an arcuate configuration, and when the piston and cylinder assemblies 170 are displaced to an expanded condition, the doors are allowed gradually to open due to the arcuate configuration of the door channels 176. There is provided for the disc-like engagement formations 175 to automatically engage the channel 176 due to the ends of the piston and cylinder assemblies 170 being naturally biased towards the flanges 177 of the container. When a piston and cylinder assembly is initially displaced from a retracted to an extended position, the disc-like engagement formation will slide over the raised profile of the guide channel 176. Once the disc-like engagement formation has passed the channel, it will be automatically be displaced towards the flange 177 form which the channel 176 extends, and subsequent upward movement will result in the disc-like engagement formation 175 to engage the channel, thus keeping the doors in a closed position. When the doors are ready to be opened, the piston and cylinder assemblies will be gradually displaced to a fully extended position, and the arcuate channel 176 will slide along the disc-like engagement formation 175, thus causing the gradual opening of the door. It will be appreciated that, as for the second embodiment 100, the engagement of the actuating mechanism with the door(s) of the container is an automatic process, and no manual intervention is required. In the first embodiment there will be manual intervention, as the chain of the actuating mechanism needs to be manually secured to the door(s).

In use, the container 12 is loaded with a particular charge while the displaceable floor 13 (which may comprise on ore more displaceable sections) is in a closed position. At this time the floor 13 is still locked to the container by way of a suitable locking arrangement 15, and cannot be displaced to the open position. When the load of the container 12 is to be discharged, the container handling arrangement 10, 100 or 150 is lowered onto the upper end of the container by way of some external hoisting means, such as a crane, in the case of the first embodiment, and by way of a standard spreader engaged to the container handling arrangement in the case of the second and third embodiments. Once the container handling arrangement 10 nests on the container, and the corner engagement sections of the handling arrangement overlies the corners of the container, the locking pin assemblies are actuated in order for the frame structure 20 securely to engage the container. The relevant actuation mechanism subsequently engages the floor 13 or an opening mechanism of the container 12 (manually in the first embodiment, and automatically in the second and third embodiments), and the actuating mechanism remains in a secured position so as to keep the floor in the closed position. At this time the container door locks 25 can be released, as the floor is kept in position by the actuation mechanism.

The container handling arrangement can subsequently be lifted, in so doing also lifting the container to which it is secured. The entire assembly can then be displaced to a location where the load is to be discharged. Once properly positioned, the actuation mechanism is displaced to the release position so as to allow the floor to pivot to an open position under the bias of the weight of the floor, as well as the load exerting a force on the door(s). It will be appreciated that this may mean displacement of the chain 27, sliding of the slideable pin 140, or displacement of the piston and cylinder assembly 170, depending on the particular embodiment.

At this time, a vibration device, which may also be mounted on the frame structure, or inside the housing, may be activated in order to cause the container to vibrate, which will assist in the discharging of the container. After the load has been discharged, the floor can be closed by again displacing the actuating mechanism to the secure position.

The inventor foresees that the container handling formation described above will be very useful in the handling and discharging of bottom discharge containers. In addition, the process will be safe, as various interlocks and safety measure can be introduced to ensure proper operation of the handling arrangement. For example, the corner arrangement section may be prevented from being disengaged when the container does not abut a lower support surface.

It will be appreciated that the above is only some embodiments of the invention and that there may be many variations without departing from the spirit and/or the scope of the invention.

1. A container handling arrangement, suitable for handling a bottom discharge container having a floor, at least a portion of which is displaceable between a closed position and an open position, the handling arrangement including:
a frame structure adapted releasably to engage the container; and
an actuating mechanism provided on the frame structure, the actuating mechanism being displaceable between a secure position in which it retains the floor of the container in a closed position, and a release position, in which it allows the floor of the container to be displaced to the open position.

2. The container handling arrangement of claim 1 in which at least one actuating mechanism is provided at each end of the frame structure in order to engage the displaceable floor on opposite ends thereof.

3. The container handling arrangement of claim 1 in which two actuating mechanisms are provided at each end of the frame structure, in order to be able to engage a displaceable floor comprising two opposing hinged door sections.

4. The container handling arrangement of any one of claim 2 in which each actuating mechanism is in the form of a piston and cylinder assembly that extends from the frame structure, with a free end of the piston and cylinder assembly being adapted to engage the displaceable floor of the container.

5. The container handling arrangement of claim 4 in which each free end terminates in a disc-like structure configured and dimensioned to engage a complementary guide channel extending from the displaceable floor of the container.

6. The container handling arrangement of claim 2 in which each actuating mechanism is in the form of a slideable pin that depends from the frame structure and which is slideable relative to the frame structure, and with an end of the slideable pin being adapted to engage a door release mechanism forming part of the container.

7. The container handling arrangement of claim 6 in which the slideable pin is displaceable between an open and a closed position by way of a piston and cylinder arrangement.

8. The container handling arrangement of claim 2 in which each actuating mechanism is in the form of a displaceable chain or cable extending from the frame structure, with a free end of the displaceable chain or cable being securable to the floor of the container.

9. The container handling arrangement of claim 8 in which the free end of the chain can be retracted at least partially into the frame structure towards a secure position in which it retains the floor of the container in a closed position, and can be at least partially displaced from the frame structure so as to allow the floor of the container to be displaceable under gravity to the open position.

10. The container handling arrangement of claim 1 in which the frame structure includes corner engagement arrangements adapted releasably to engage upper corners of the container.

11. The container handling arrangement of claim 10 in which the corner engaging arrangements include twist lock assemblies suitable for engaging complementary apertures provided in the corner sections of the container.

12. The container handling arrangement of claim 1 in which the frame structure includes lifting lugs for use in securing the frame structure to a hoisting mechanism.

13. The container handling arrangement of claim 1 in which the frame structure is releasably securable to a container spreader assembly by way of locking pin arrangements.

14. The container handling arrangement of claim 13 in which the locking pin arrangements are in the form of twist lock arrangements.

15. The container handling arrangement of claim 13 in which the frame structure includes auxiliary safety pins that are adapted to secure the locking pin arrangements in a locked position.

16. The container handling arrangement of claim 15 in which each safety pin is in the form of a retractable pin that can be displaced between an unlocked position, in which the pin is retracted into the frame, and a locked position in which the pin protrudes from the frame in order to engage the locking pin assemblies of the spreader.
